(19) United States
(12) Patent Application Publication
(10) Pub. No.: US 2013/0245184 A1
(43) Pub. Date: Sep. 19, 2013

(54) RESIN SLIDING MEMBER

(71) Applicant: DAIDO METAL COMPANY LTD., Nagoya (JP)

(72) Inventors: Yoshifumi ITO, Inuyama (JP); Yohei TAKADA, Inuyama (JP)

(73) Assignee: DAIDO METAL COMPANY LTD., Nagoya (JP)

(21) Appl. No.: 13/788,206

(22) Filed: Mar. 7, 2013

(30) Foreign Application Priority Data
Mar. 16, 2012 (JP) 2012-061158

(51) Int. Cl. C08K 3/10; C08K 7/00

(52) U.S. Cl. CPC C08K 3/10; C08K 7/00
USPC 524/436

(57) ABSTRACT

Disclosed is a resin sliding member, including: 0.5 to 25 vol % of calcium fluoride dispersed as particles; and a synthetic resin as a remainder. The calcium fluoride is crystalline, and a peak intensity of a (111) plane of the calcium fluoride exposed on a sliding surface is larger than a peak intensity of a (220) plane.

### INCORPORATION BY REFERENCE

The present application claims priority from JP Patent Application Ser. No. 2012-61158 filed on Mar. 16, 2012, the content of which is hereby incorporated by reference into this application.

### BACKGROUND OF THE INVENTION

(1) Field of the Invention

The present invention relates to a resin sliding member which does not contain lead or lead compounds and excels in friction and wear properties, and more particularly, to a resin sliding member suitable for a bearing of various vehicles such as an automobile, a bearing of general industrial machinery, or the like.

(2) Description of Related Art

Conventionally, synthetic resins such as fluorine resin, PEEK (polyether ether ketone) resin and PAI (polyamide-imide) resin have been widely used for a resin sliding member such as a bearing because of the excellent self-lubricating properties. In general, the resin sliding member has been used by filling it with lead or lead compounds to provide wear resistance and seize resistance. In recent years, however, since lead and lead compounds have been considered as environmentally hazardous substances, the use thereof should be abandoned. For this reason, various fillers have been proposed as an alternative material of lead or lead compounds, and for example, JP-A-61-118452 proposes that calcium fluoride is a filler excellent in wear resistance.

### BRIEF SUMMARY OF THE INVENTION

As described in JP-A-61-118452, a resin sliding member in which a metal fluoride, in particular calcium fluoride is contained in a fluorine resin has the advantage of capable of increasing wear resistance of the resin sliding member by suppressing a strength reduction of a fluorine resin matrix. However, since the fluorine resin becomes worn after initial wear and the rigid calcium fluoride comes in direct contact with an opposed shaft, a friction coefficient is increased, and the resin sliding member cannot obtain excellent sliding properties. The present invention has been made in view of the circumstances, and it is an object of the present invention to provide a resin sliding member capable of suppressing a friction coefficient increase during steady wear while maintaining excellent wear resistance.

In order to achieve the above-described object, according to a first embodiment of the invention, in a resin sliding member comprising 0.5 to 25 vol % of calcium fluoride dispersed as particles and a synthetic resin as a remainder, the calcium fluoride is crystalline, and a peak intensity of a (111) plane of the calcium fluoride exposed on a sliding surface is larger than a peak intensity of a (220) plane.

According to a second embodiment of the invention, an average particle diameter of the calcium fluoride is 1 to 20 μm.

In the first embodiment of the invention, in a resin sliding member comprising 0.5 to 25 vol % of calcium fluoride dispersed as particles and a synthetic resin as a remainder, the calcium fluoride is crystalline, and a peak intensity of a (111) plane of the calcium fluoride exposed on a sliding surface is made larger than a peak intensity of a (220) plane. The (111) plane of the calcium fluoride which is crystalline is a cleavage plane, and by making many (111) cleavage planes exist on particle surfaces of the calcium fluoride exposed on the sliding surface, a friction coefficient increase during steady wear can be suppressed.

Natural calcium fluoride has crystal orientation in which the peak intensity of the (220) plane is larger than the peak intensity of the (111) plane. In the case where a resin sliding member in which the calcium fluoride having such crystal orientation is dispersed in a synthetic resin is used, the calcium fluoride and the synthetic resin on a sliding surface of the resin sliding member slide in contact with an opposed shaft during initial wear, and the synthetic resin on the sliding surface preferentially becomes worn and the calcium fluoride projects on the sliding surface during steady wear. And then, when the calcium fluoride projecting on the sliding surface of the resin sliding member mainly slides in contact with the opposed shaft, a friction coefficient during steady wear is likely to be increased.

However, in the resin sliding member of the present invention, by dispersing, into the synthetic resin, particles of the calcium fluoride in which crystals are oriented such that many (111) cleavage planes exist on surfaces thereof, the calcium fluoride causes micro-shear (cleavage) on the cleavage planes inside of crystals near the particle surfaces when the calcium fluoride is in contact with the opposed shaft, and the calcium fluoride can be prevented from projecting on the sliding surface. Therefore, a friction coefficient increase of the resin sliding member during steady wear can be suppressed.

The filler content of the calcium fluoride is set to be 0.5 to 25 vol %. When the filler content of the calcium fluoride is less than 0.5 vol %, it is difficult to sufficiently exert an effect in wear resistance. In contrast, when the filler content of the calcium fluoride is more than 25 vol %, the friction coefficient during steady wear is increased even if the peak intensity of the (111) plane of the calcium fluoride is made larger than the peak intensity of the (220) plane.

According to the second embodiment of the invention, an average particle diameter of the calcium fluoride is preferably 1 to 20 μm. As the average particle diameter of the calcium fluoride becomes smaller, a surface area per unit volume becomes larger and the calcium fluoride is tightly bonded to the synthetic resin matrix, and thus, separation of the calcium fluoride from the synthetic resin matrix is reduced. Therefore, the average particle diameter of the calcium fluoride is preferably 20 μm or less.

### BRIEF DESCRIPTION OF THE SEVERAL VIEWS OF THE DRAWING

FIG. 1 is a schematic diagram showing a resin sliding member in which calcium fluoride is dispersed in a PTFE;

FIG. 2 is a diagram showing a measurement result of an XRD method of calcium fluoride according to the present embodiment;

FIG. 3 is a diagram showing a measurement result of the XRD method of calcium fluoride according to the present embodiment; and

FIG. 4 is a diagram showing results of a sliding test using a resin sliding member according to the present embodiment.

### DETAILED DESCRIPTION OF THE INVENTION

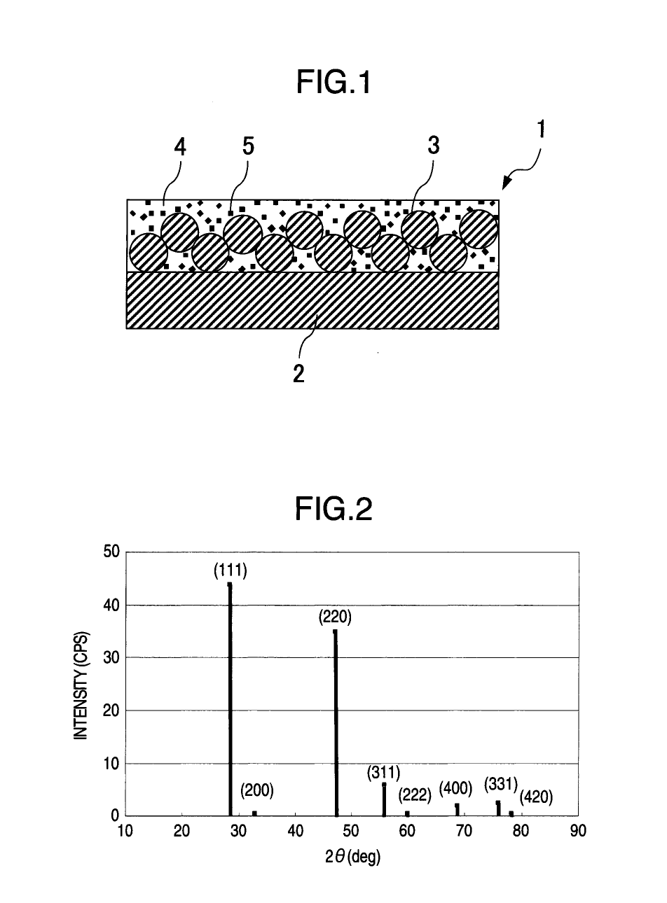

A resin sliding member 1 according to the present embodiment, in which calcium fluoride 5 is dispersed in a polytetrafluoroethylene (hereinafter referred to as “PTFE”) 4, was manufactured by the processes described below. Firstly, the PTFE 4 (“CD097 (trade name)” manufactured by Asahi Glass Co., Ltd.) and the calcium fluoride 5 were stirred and mixed at a compositional ratio shown in Table 1, and 25 wt % of a petroleum solvent (“Isopar H (trade name)” manufactured by Exxon Mobil Corporation) was added to 100 wt % of the obtained mixture for further stirring and mixing. Next, the surface of a metal base material was covered with the obtained resin composition, which was dried by heating to remove the petroleum solvent and then baked. A material composed of a steel back metal layer 2 and a porous metal layer 3, which was prepared in advance, was used as the metal base material, and the side of the porous metal layer 3 was impregnated and covered with a resin composition. Then, by forming the metal base material into a cylindrical shape such that the resin composition is located on the inner diameter side, the resin sliding member 1 in which the calcium fluoride 5 is dispersed in the PTFE 4 was manufactured as shown in FIG. 1. Regarding Examples 1 to 4 and Comparative Examples 1 and 2, a component composition of the PTFE 4 and calcium fluoride 5, a peak intensity ratio between a (111) plane and a (220) plane of the calcium fluoride 5, and a friction coefficient after 100 hours from the start of a sliding test are shown in Table 1.

TABLE 1

| | | | | | | Comparative | Comparative |
|---|---|---|---|---|---|---|---|
| | | Example 1 | Example 2 | Example 3 | Example 4 | Example 1 | Example 2 |
| component | PTFE | 99.5 | 90 | 75 | 90 | 90 | 90 |
| composition | calcium fluoride | 0.5 | 10 | 25 | 10 | 10 | 10 |
| (vol %) | | | | | | | |

| | | | | | | |
|---|---|---|---|---|---|---|
| peak intensity ratio between | 1.3:1 | 1.3:1 | 1.3:1 | 1.1:1 | without crystalline | 0.9:1 |
| (111) plane and (220) plane | | | | | structure | |
| of calcium fluoride | | | | | | |
| friction coefficient after | 0.10 | 0.11 | 0.15 | 0.14 | 0.25 | 0.24 |
| 100 hours | | | | | | |

In Examples 1 to 3, as for the calcium fluoride 5, calcium fluoride was used which was pulverized by sequentially repeating; a step for rapidly rotating a cylindrically-shaped case storing natural calcium fluoride powders in a dry state therein in the circumferential direction and pressing the powders against the inner wall surface by centrifugal force to form a powder layer; a step for pressing the powder layer against the inner wall surface in such a way as to rub the powder layer on the inner wall surface with a slider to apply compression force; and a step for scraping the powder layer from the inner wall surface and shearing the scraped powder layer, and which calcium fluoride was made to have a crystalline orientation such that the peak intensity ratio between the (111) plane and the (220) plane of the calcium fluoride 5 was 1.3:1 when measured by an XRD method. The measurement result of the XRD method of the calcium fluoride 5 is shown in FIG. 2. In addition, even after manufacturing the resin sliding member 1 in which the calcium fluoride 5 was dispersed in the PTFE 4, the peak intensity ratio between the (111) plane and the (220) plane of the calcium fluoride 5 was 1.3:1 when the calcium fluoride 5 exposed on a sliding surface was measured by the XRD method. In the present embodiment, the calcium fluoride 5 manufactured by the above steps was pulverized by using “Ongmill (trade name)” manufactured by Hosokawa Micron Corporation. In Example 1, the calcium fluoride 5 having an average particle diameter of 1 μm was mixed into the PTFE 4 at a compositional ratio of 0.5 vol %. In contrast, in Example 2, the calcium fluoride 5 having an average particle diameter of 6 μm was mixed into the PTFE 4 at a compositional ratio of 10 vol %, and in Example 3, the calcium fluoride 5 having an average particle diameter of 20 μm was mixed into the PTFE 4 at a compositional ratio of 25 vol %.

In Example 4, the calcium fluoride 5 was used which was manufactured by the similar method to that of Examples 1 to 3, but the pressure for pressing the powder layer against the case inner wall surface was decreased to about 70% of that in manufacturing of Examples 1 to 3. As a result, the calcium fluoride 5 in Example 4 was made to have a crystalline orientation such that the peak intensity ratio between the (111) plane and the (220) plane of the calcium fluoride 5 was 1.1:1 when measured by the XRD method. Even after manufacturing the resin sliding member 1 in which the calcium fluoride 5 was dispersed in the PTFE 4, the peak intensity ratio between the (111) plane and the (220) plane of the calcium fluoride 5 was 1.1:1 when the calcium fluoride 5 exposed on the sliding surface was measured by the XRD method. In addition, in Example 4, the calcium fluoride 5 having the average particle diameter of 6 μm was mixed into the PTFE 4 at a compositional ratio of 10 vol %.

In contrast, in Comparative Example 1, calcium fluoride was used which was obtained by adding a calcium chloride solution to a saturated sodium fluoride solution to prepare calcium fluoride by a precipitation method, separating a precipitate, washing and removing sodium and chlorine by centrifugation and filtration, and drying and pulverizing. Similar to the calcium fluoride described in JP-A-61-118452, the calcium fluoride obtained by the method is amorphous, and does not have a crystalline structure. In Comparative Example 1, the calcium fluoride was mixed into the PTFE 4 at a compositional ratio of 10 vol %.

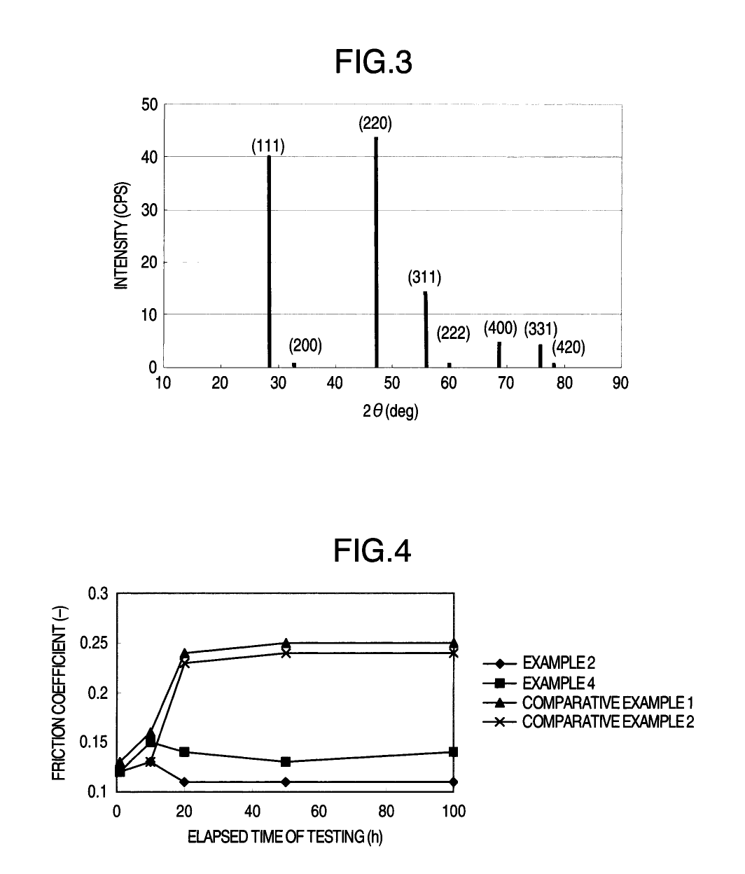

Moreover, in Comparative Example 2, the calcium fluoride was used which was obtained by pulverizing natural calcium fluoride with a ball mill, and in which the peak intensity ratio between the (111) plane and the (220) plane of the calcium fluoride was 0.9:1 when measured by the XRD method. The measurement result of the XRD method of the calcium fluoride 5 is shown in FIG. 3. In addition, even after manufacturing the resin sliding member in which the calcium fluoride was dispersed in the PTFE, the peak intensity ratio between the (111) plane and the (220) plane of the calcium fluoride was 0.9:1 when the calcium fluoride was measured at the sliding surface by the XRD method. In Comparative Example 2, the calcium fluoride 5 having the average particle diameter of 6 μm was mixed into the PTFE 4 at a compositional ratio of 10 vol %.

In the manufacturing method of the calcium fluoride powder in Examples 1 to 4, following steps are sequentially repeated: the step for pressing the powders against the inner wall surface by centrifugal force to form the powder layer; the step for pressing the powder layer against the inner wall surface in such a way as to rub the powder layer on the inner wall surface with the slider to apply compression force; and the step for scraping the powder layer from the inner wall surface and shearing the scraped powder layer. Among these steps, in the step for pressing the powder layer against the inner wall surface in such a way as to rub the powder layer on the inner wall surface with the slider to apply compression force, the calcium fluoride is likely to cause cleavage on (111) cleavage planes due to the compression force, and many cleavage planes are newly exposed. The newly-exposed cleavage plane is likely to be bonded to another newly-exposed cleavage plane because of its active state. However, in the step for scraping the powder layer from the inner wall surface and shearing the scraped powder layer, the powder layer is scraped while maintaining the newly-exposed (111) cleavage planes. Thus, the cleavage planes do not have much contact with each other, and recombination between the cleavage planes is reduced. Accordingly, it is thought that many (111) cleavage planes exist on particle surfaces of the calcium fluoride. In contrast, in Comparative Example 2, a general ball mill was used in which a hard ball made of a ceramic material or the like and a material to be pulverized were put into a container and the material was pulverized. In the case where natural calcium fluoride is pulverized with the ball mill, even if the (111) cleavage planes are newly exposed, the cleavage planes often come into contact with each other when using the ball mill, and the cleavage planes are likely to be recombined with each other. Therefore, it is thought that the crystal orientation of the particles obtained by pulverizing the natural calcium fluoride with the ball mill is not changed from that of the calcium fluoride before the pulverization.

Next, with respect to Examples 1 to 4 using the resin sliding member 1 according to the present embodiment and Comparative Examples 1 and 2, the sliding test was performed with a sliding testing machine in an unlubricated condition. The sliding test was performed under testing conditions shown in Table 2 after press fitting the manufactured resin sliding member 1 into a housing, and friction coefficients were measured. As for the test results of Examples 1 to 4 and Comparative Examples 1 and 2, friction coefficients after 100 hours from the start of the test are shown in Table 1. Moreover, among Examples 1 to 4 and Comparative Examples 1 and 2, as for the test results of Examples 2 and 4 and Comparative Examples 1 and 2, in which the calcium fluoride 5 having the average particle diameter of 6 μm was mixed into the PTFE 4 at a compositional ratio of 10 vol %, changes in the friction coefficients from the start to 100 hours of the test is shown in FIG. 4.

TABLE 2

| item | condition |
|---|---|
| contact pressure | 9.8 MPa |
| circumferential speed | 3 m/min |
| shaft material | SUJ2 hardening |
| testing shaft roughness | Ra 0.3 μm or less |

As shown in Table 1, in Examples 1 to 4, the friction coefficients after 100 hours from the start of the test are stably low within the range of 0.10 to 0.15. In contrast, in Comparative Examples 1 and 2, the friction coefficients after 100 hours from the start of the test are high within the range of 0.24 to 0.25. That is, by making the peak intensity of the (111) plane of the calcium fluoride 5 exposed on the sliding surface be larger than that of the (220) plane, the friction coefficient during steady wear can be kept low.

In addition, as shown in FIG. 4, in Examples 2 and 4 and Comparative Examples 1 and 2, the friction coefficient for any example from the start to 10 hours of the test is stably low within the range of 0.10 to 0.16. However, in Comparative Examples 1 and 2, when more than 20 hours pass and initial wear is finished, the friction coefficients are drastically increased. The friction coefficients are kept as high as about 0.25 without any reduction 50 to 100 hours after the start. In contrast, in Examples 2 and 4, the friction coefficients from the start to 100 hours of the test are stably low within the range of 0.10 to 0.20. That is, by making the peak intensity of the (111) plane of the calcium fluoride 5 exposed on the sliding surface be larger than that of the (220) plane, a friction coefficient increase during not only initial wear but also steady wear can be suppressed.

In the present embodiment, the PTFE 4 (fluorine resin) is used as a base synthetic resin. However, in the case where a synthetic resin other than the fluorine resin is used, increase in the friction coefficient of the resin sliding member 1 can be effectively suppressed by dispersing the calcium fluoride 5 of the present invention in the synthetic resin. In addition, the base synthetic resin may be made of two or more kinds of synthetic resins, and the synthetic resins may be polymer alloyed.

Moreover, in the present embodiment, the resin sliding member 1 made of the PTFE 4 as the base synthetic resin and the calcium fluoride 5 is shown. However, the resin sliding member 1 may further contain a solid lubricant such as graphite or molybdenum disulfide, and another filler such as an inorganic compound, for example, barium sulfate, calcium phosphate, potassium titanate or alumina. Furthermore, the resin sliding member 1 may contain as filler a different kind of synthetic resin from the base synthetic resin.

In the present embodiment, the porous part and the surface of the porous metal layer 3 formed on the steel back metal layer 2 was impregnated and covered with the composition of the resin sliding member 1. However, a base material such as a steel back metal layer may be covered with the composition of the resin sliding member 1 without forming a porous metal layer on the steel back metal layer. Moreover, the resin sliding member 1 of the present invention may be used without covering a base material.

1. A resin sliding member, comprising:
0.5 to 25 vol % of calcium fluoride dispersed as particles; and
a synthetic resin as a remainder,
wherein the calcium fluoride is crystalline, and
a peak intensity of a (111) plane of the calcium fluoride exposed on a sliding surface is larger than a peak intensity of a (220) plane.

2. The resin sliding member according to claim 1, wherein an average particle diameter of the calcium fluoride is 1 to 20 μm.
